(19) United States
(12) Patent Application Publication
(10) Pub. No.: US 2017/0277986 A1
(43) Pub. Date: Sep. 28, 2017

(54) IMAGE FORMING APPARATUS, IMAGE FORMING METHOD AND NON-TRANSITORY COMPUTER READABLE MEDIUM

(71) Applicant: FUJI XEROX CO., LTD., Tokyo (JP)

(72) Inventors: Satoshi Hanamura, Kanagawa (JP); Ligang Liao, Kanagawa (JP); Masanori Shiba, Kanagawa (JP); Takayuki Nakao, Kanagawa (JP); Tsunaki Tsuji, Kanagawa (JP); Takahiro Shiomi, Kanagawa (JP); Takahiro Tojo, Kanagawa (JP)

(21) Appl. No.: 15/201,735

(22) Filed: Jul. 5, 2016

(30) Foreign Application Priority Data
Mar. 24, 2016 (JP) 2016-059415

(51) Int. Cl. G06K 15/00

(52) U.S. Cl. CPC G06K 15/4065

(57) ABSTRACT

There is provided an image forming apparatus. A receiving unit receives image data. A plurality of supply units supplies different sizes of recording media. A tray detecting unit detects a supply unit to be set as a supply target from the plurality of supply units. A switching unit, according to the remaining number of recording media accommodated in the supply unit, makes a switch from supply by a supply unit, of the plurality of supply units, accommodating a recording medium of a size required for image formation to supply by another supply unit detected by the tray detecting unit. An adjusting unit adjusts the image data received by the receiving unit to have the same output image size regardless of a switching operation by the switching unit.

### CROSS-REFERENCE TO RELATED APPLICATIONS

This application is based on and claims priority under 35 U.S.C, §119 from Japanese Patent Application No, 2016-059415 filed on Mar. 24, 2016

### TECHNICAL FIELD

The present invention relates to an image forming apparatus, an image forming method and a non-transitory computer readable medium.

### RELATED ART

A printing device including multiple paper feeding trays has a function of feeding paper from a replacement tray without requesting feeding of paper (hereinafter, referred to as an SPS (Substitute Paper Selection)) in order to avoid a stoppage of printing due to exhaustion of paper. However, paper sizes may be rendered irregular, or image sizes may be rendered irregular because images are shrunk in accordance with the paper for printing.

### SUMMARY

According to an aspect of the embodiments of the present invention, there is provided an image forming apparatus comprising: a receiving unit that receives image data; a plurality of supply units that supplies different sizes of recording media; a tray detecting unit that detects a supply unit to be set as a supply target from the plurality of supply units; a switching unit that, according to the remaining number of recording media accommodated in the supply unit, makes a switch from supply by a supply unit, of the plurality of supply units, accommodating a recording medium of a size required for image formation to supply by another supply unit detected by the tray detecting unit; and an adjusting unit that adjusts the image data received by the receiving unit to have the same output image size regardless of a switching operation by the switching unit.

### BRIEF DESCRIPTION OF THE DRAWINGS

Exemplary embodiments of the present invention will be described in detailed based on the following figures, wherein:

FIG. 1 is a schematic diagram illustrating an image timing system according to one exemplary embodiment of the present invention;

FIG. 2 is a diagram illustrating a schematic configuration of image forming apparatus according to one exemplary embodiment of the present invention;

FIG. 3 is a block diagram illustrating a control configuration of the image forming apparatus according to one exemplary embodiment of the present invention;

FIG. 4 is a block diagram illustrating a functional configuration of the image forming apparatus according to one exemplary embodiment of the present invention;

FIG. 5 is a diagram illustrating an example of a display screen of a UI (User Interface) device according to one exemplary embodiment of the present invention;

FIG. 6 is a flowchart illustrating a recording medium paper feeding operation of the image forming apparatus according to one exemplary embodiment of the present invention;

FIG. 7 is a flowchart illustrating a recording medium paper feeding operation of the image forming apparatus according to one exemplary embodiment of the present invention;

FIG. 8 is a diagram illustrating one example of a printing result of the image forming apparatus according to one exemplary embodiment of the present invention;

FIG. 9 is a diagram illustrating one example of a printing result of the image forming apparatus according to one exemplary embodiment of the present invention;

FIG. 10 is a diagram illustrating one example of a printing result of image forming apparatus according to one exemplary embodiment of the present invention;

FIG. 11 is a diagram illustrating one example of a printing result of the image forming apparatus according to one exemplary embodiment of the present invention; and

FIG. 12 is a diagram illustrating one example of a printing result of an image forming apparatus according to a comparative example.

### DETAILED DESCRIPTION

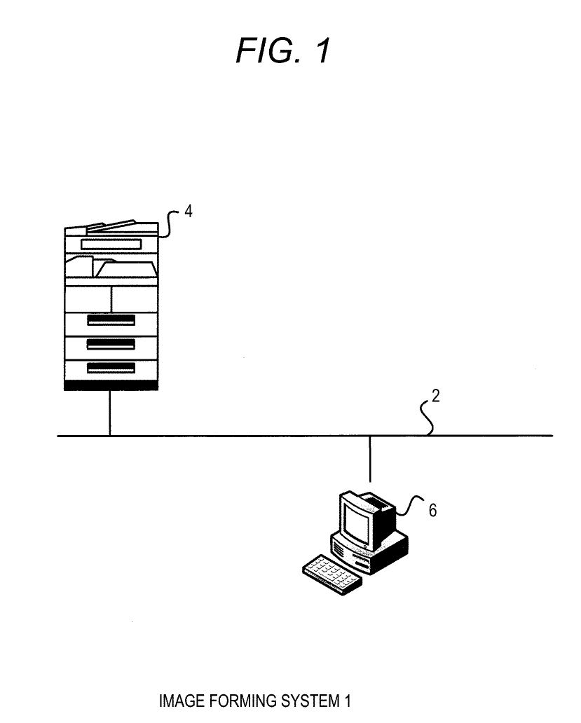

Hereinafter, one exemplary embodiment of the present invention will be described in detail with reference to the drawings. FIG. 1 is a schematic diagram illustrating an image forming system 1 according to one exemplary embodiment of the present invention. As illustrated in FIG. 1, the image forming system 1 is configured of an image forming apparatus 4 and a terminal apparatus 6 that are connected to each other by a network 2. The number of image forming apparatuses 4 and the number of terminal apparatuses 6 are not limited. Alternatively, a terminal apparatus and an image forming apparatus may be locally connected in a one-to-one manner.

The terminal apparatus 6 illustratively includes a user interface (UI) device 10, generates print data, and sends the generated print data to the image forming apparatus 4 via the network 2.

The UI device 10 includes a touch panel or a liquid crystal display, a keyboard, and the like and, for example, receives or displays selection of the content of processing by the image forming apparatus 4.

The image forming apparatus 4 receives the print data sent from the terminal apparatus 6 and outputs an image on a recording medium in accordance with the print data.

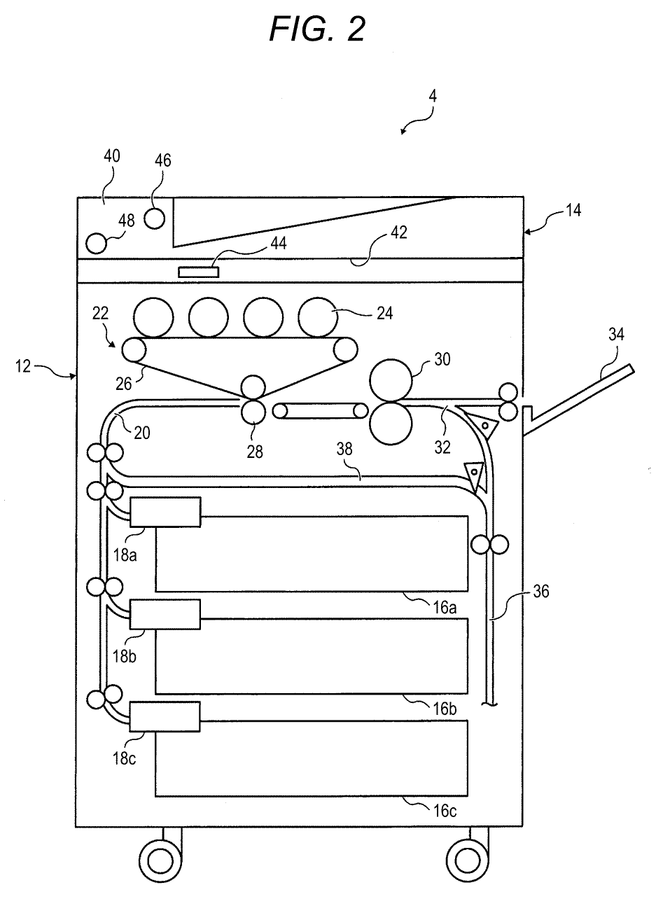

FIG. 2 is a sectional view illustrating the image forming apparatus 4. The image forming apparatus 4 includes a printing device 12 and an image reading device 14.

The printing device 12 includes, for example, a paper feeding unit 16a, a paper feeding unit 16b, and a paper feeding unit 16c constituting three stages as a supply unit that accommodates and supplies a recording medium to an image forming unit 22 described later. A paper feeding head 18a, a paper feeding head 18b, and a paper feeding head 18c are respectively provided in the paper feeding unit 16a, the paper feeding unit 16b, and the paper feeding unit 16c.

The paper feeding unit 16a, the paper feeding unit 16b, and the paper feeding unit 16c are configured so that different sizes of recording media may be accommodated and that different sizes of recording media may be fed to the image forming unit 22.

When one of the paper feeding unit 16a, the paper feeding unit 16b, and the paper feeding unit 16c is selected, a corresponding paper feeding head 18 is operated to feed paper from a selected paper feeding unit 16 to the image forming unit 22 through a recording medium supply path 20.

The image forming unit 22 includes individual photoconductors 24 of yellow, magenta, cyan, and black and, an intermediate transfer belt 26.

A charging unit, an exposure unit, a developing unit, a primary transfer unit, a cleaning unit, and the like (not illustrated) are provided around each photoconductor 24. Toner images formed on each photoconductor 24 are transferred to the intermediate transfer belt 26. Only the black photoconductor is operable in a case where settings are made for black and white printing.

The toner image of the intermediate transfer belt 26 is transferred by a secondary transfer roll 28 to the transported recording medium and is fixed by a fixing unit 30. The recording medium on which the toner image is fixed is output to an output unit 34 through a recording medium output path 32.

The recording medium of which the surface is fixed by the fixing unit 30, in a case where settings are made for duplex printing, is transported from the recording medium output path 32 to a reversing unit 36, reversed by the reversing unit 36, and transported to a recording medium reversal path 38 and returns to the recording medium supply path 20 and is transported to the image forming unit 22 again, and printing is performed on the rear surface of the recording medium.

The image reading device 14 includes an auto document feeder 40 that allows reading of both sides of an original document. The auto document feeder 40 transports an original document to a platen 42, and the image of the original document is read by a reading unit 44 configured of a CCD and the like on the platen 42.

An original document setting detector 46 that detects whether or not an original document is set is provided in the auto document feeder 40. The auto document feeder 40 functions as a platen cover as well. Opening the platen cover allows the original document to be placed on the platen 42. Opening and closing of the platen cover may be detected by a platen cover opening and closing detector 48.

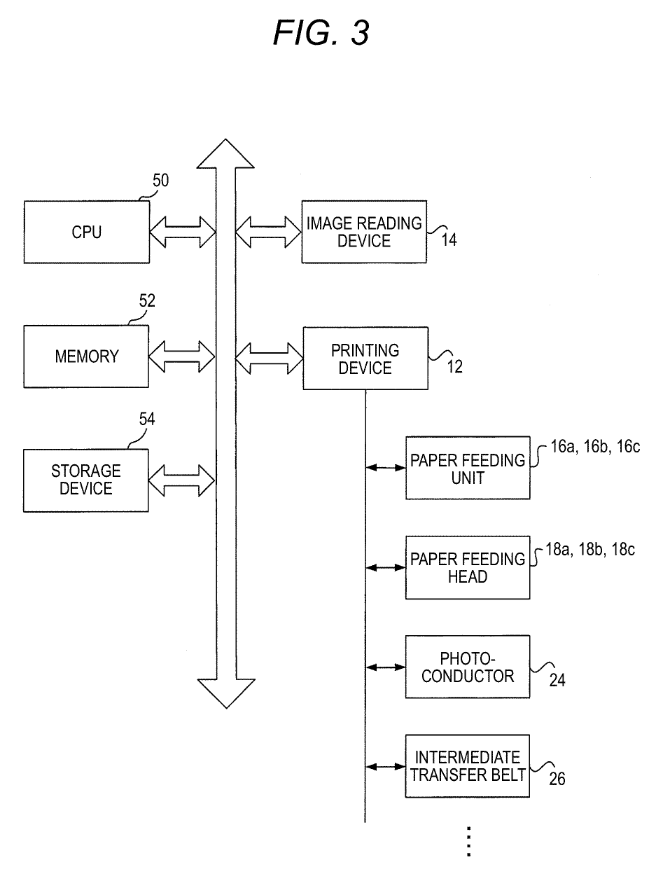

FIG. 3 is a block diagram illustrating a control configuration of the image forming apparatus 4.

As illustrated in FIG. 3, the image forming apparatus 4 is configured to include, in addition to the printing device 12 and the image reading device 14, a CPU 50, a memory 52, and a storage device 54 that are connected through a bus.

The CPU 50 executes a program stored in the memory 52 or in the storage device 54 to control operation of the image forming apparatus 4. Input that is received through the UI device 10 of the terminal apparatus 6 is transmitted to the CPU 50, and display information is transmitted from the CPU 50 to the UI device 10.

The CPU 50 may execute a program that is stored in a portable storage medium not illustrated, such as a CD-ROM, or may execute a program that is provided through a communication device not illustrated.

The storage device 54 uses, for example, a hard disk and stores data in a manner that allows writing and reading of data.

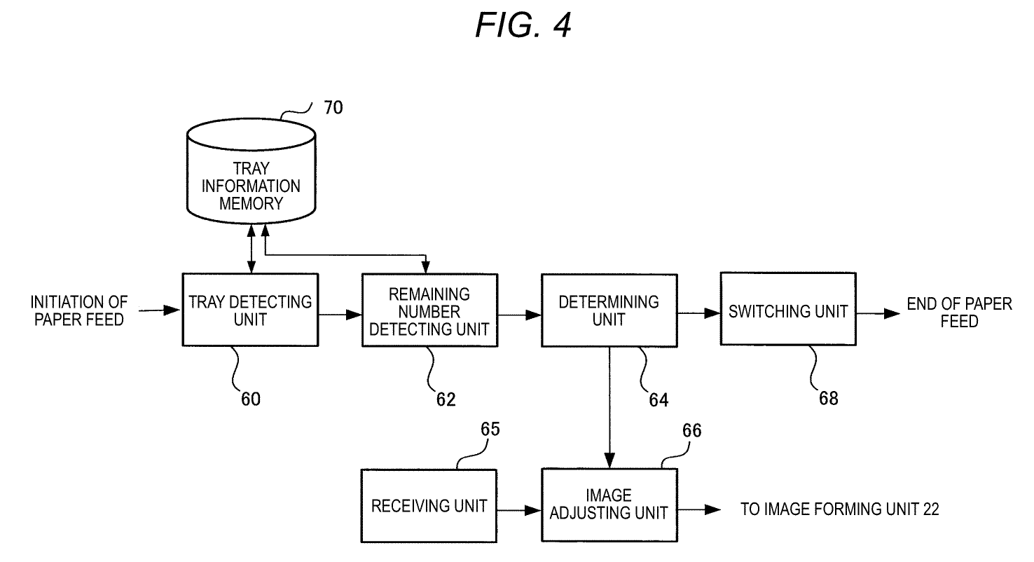

FIG. 4 is a block diagram illustrating a functional configuration of the image forming apparatus 4 realized by executing the control program.

The image forming apparatus 4 of the present exemplary embodiment includes a tray detecting unit 60, a remaining number detecting unit 62, a determining unit 64, a receiving unit 65, an image adjusting unit 66, and a switching unit 68 as illustrated in FIG. 4.

The tray detecting unit 60 detects, as a user-specified tray, the paper feeding unit 16 that accommodates a recording medium of a size required for image formation, from tray information stored in a tray information memory 70. In addition, the tray detecting unit 60 detects, as replacement trays, other paper feeding units 16 that accommodate recording media used instead of the recording medium of the size required for image formation, and assigns a priority order to the detected paper feeding units 16 on the basis of specification provided by a user.

The remaining number detecting unit 62 detects the remaining, number of recording media that are accommodated in the paper feeding unit 16 detected as a paper feeding target tray, from the tray information stored in the tray information memory 70.

The determining unit 64 determines whether or not to make a switch from the user-specified tray to a replacement tray in accordance with the remaining number of recording media in the paper feeding unit 16 detected as a user-specified tray and in the other paper feeding units 16 detected as replacement trays. In addition, the determining unit 64 determines whether or not the area in which a printable area of the recording medium accommodated in the paper feeding unit 16 determined as a paper feeding target tray is smaller than a printable area of a job.

The receiving unit 65 receives image data sent from the terminal apparatus 6.

The image adjusting unit 66 sets and adjusts a printable area in such a manner that the image data received by the receiving unit 65 has the same output image size. In addition, the image adjusting unit 66 sets and adjusts the printable area in accordance with the size of the output recording medium. In addition, the image adjusting unit 66 sets and adjusts the printable area without changing the image size of the received image data.

The switching unit 68 perform a paper feeding switching operation between the paper feeding unit 16 detected as a user-specified tray and the other paper feeding units 16 detected as replacement trays.

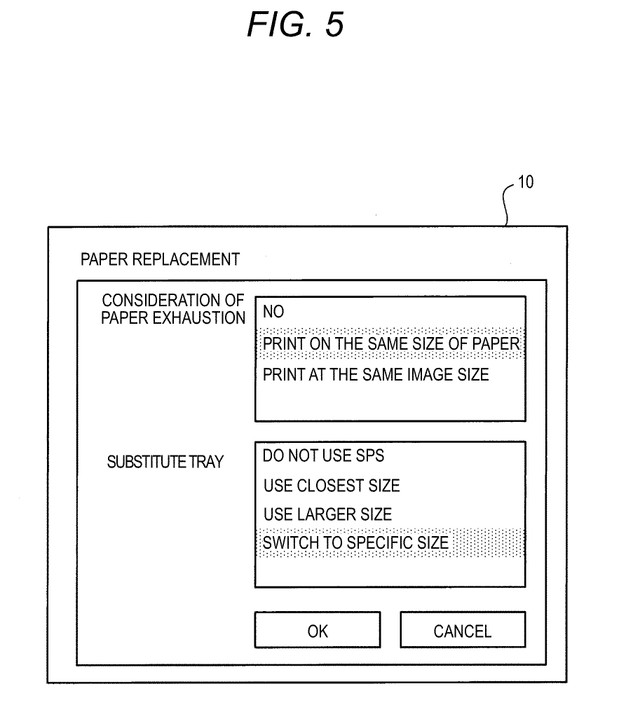

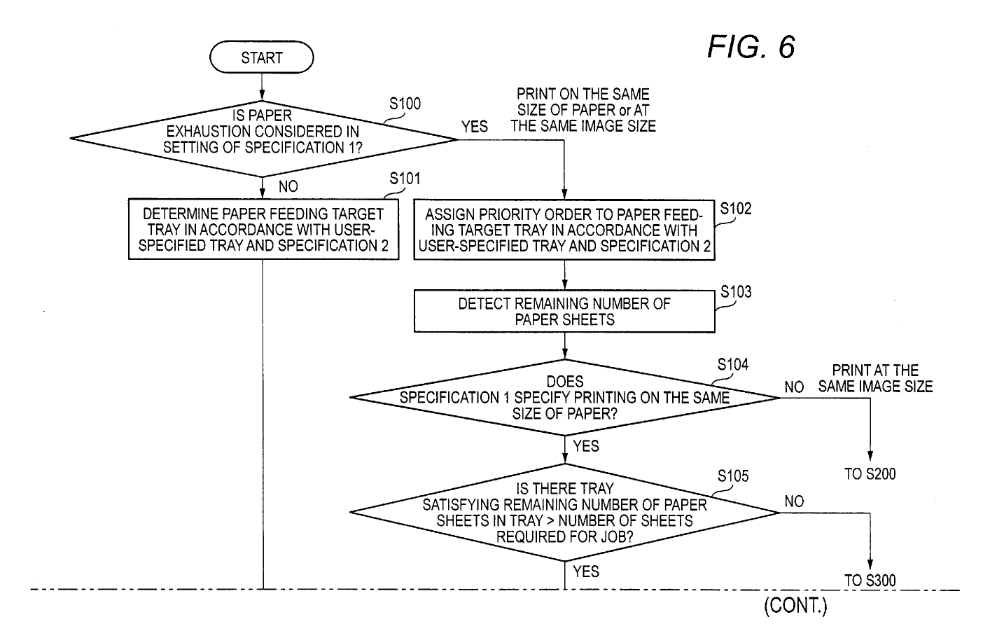

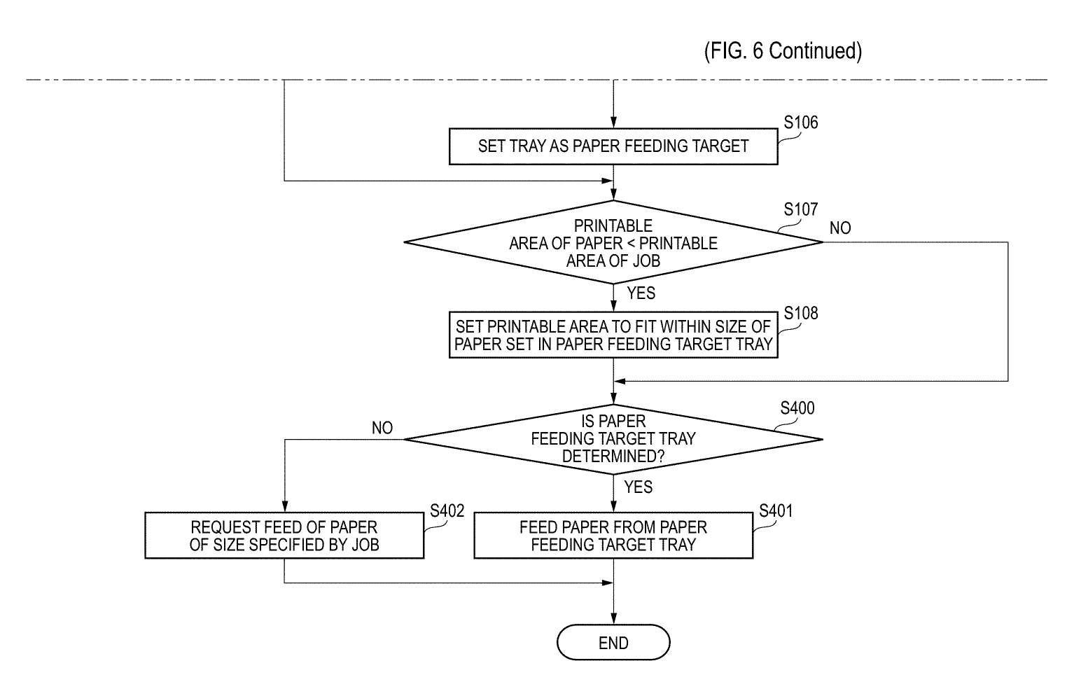

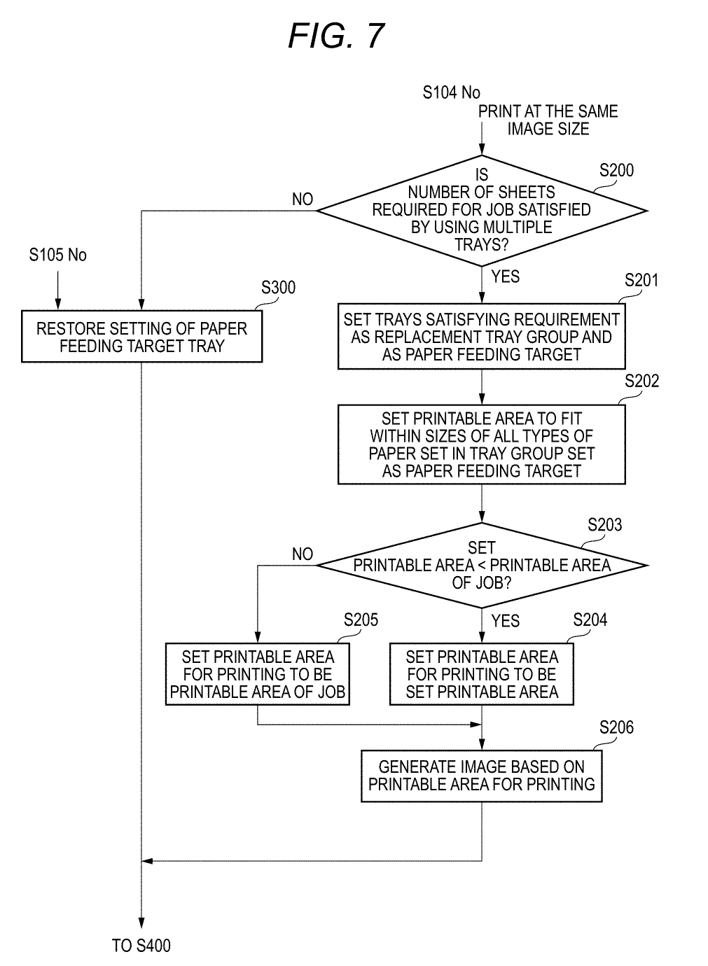

Next, a paper feeding operation of the image forming apparatus 4 according to one exemplary embodiment of the present invention will be described by using FIG. 5 to FIG. 7. FIG. 5 is a diagram illustrating one example of a display screen of the UI device 10 of the terminal apparatus 6. FIG. 6 and FIG. 7 are flowcharts illustrating the paper feeding operation of the image forming apparatus 4. Paper will be described as one example of the recording medium.

First, the user who uses the terminal apparatus 6 specifies the paper size, the number of sheets required, the feed of paper from the paper feeding unit 16 when paper is exhausted, and an SPS on the display screen of the UI device 10 of the terminal apparatus 6 and sends a specified job to the image forming apparatus 4. The paper feeding unit 16a will be described as a user-specified tray that accommodates paper of a size specified by the job, and the paper feeding unit 16b or the paper feeding unit 16c will be described as a replacement tray that accommodates paper of a size not equal to the size specified by the job and is used instead of the user-specified tray when paper in the user specific tray is exhausted.

Specifically, the user specifies, as a specification 1, one of items “No”, “Print on the same size of paper”, and “Print at the same image size” in a section “Consideration of paper exhaustion” on a display screen of “Substitute Tray” illustrated in FIG. 5, in addition, the user specifies, as a specification 2, one of items “Do not use SPS”, “Use Closest Size”, “Use Larger Size”, and “Switch to a specific size” in a section “Substitute Tray” and presses an “OK” button,

The image forming apparatus 4 performs the processes below after receiving the job from the terminal apparatus 6.

A determination as to whether or not “Consideration of paper exhaustion” is made in the specification 1 is performed in Step 100 (S100). A transition is made to Step 101 (S101) in a case where “No” is specified. A transition is made to Step 102 (S102) in a case where either “Print on the same size of paper” or “Print at the same image size” is specified.

The tray detecting unit 60 determines a paper feeding target tray in accordance with the user-specified tray and the specification of the specification 2 in Step 101 (S101), and a transition is made to subsequent Step 107 (S107).

The tray detecting unit 60 assigns a priority order to papers feeding target trays in accordance with the user-specified tray and the specification of the specification 2 in Step 102 (S102). Specifically, when the user-specified tray is, for example, an A4-size tray, only the, user-specified tray is determined to be a paper feeding target tray in a case where the specification 2 specifies “Do not use SPS”. A paper feeding target tray, in a case where the specification 2 specifies “Use Closest Size”, is determined by assigning a priority order to the A4-size tray, which is the user-specified tray, a letter-size tray that is a replacement tray most similar to the A4 size, a tray of a size that is the next most similar to the letter size, and a tray of a size that is the second next most similar to the letter size. A paper feeding target tray, in a case where the specification 2 specifies “Use Larger Size”, is determined by assigning a priority order to the A4-size tray, which is the user-specified tray, an A3-size tray that is a replacement tray one size larger than the A4 size, a tray of a size that is the next largest to the A3-size, and a tray of a size that is the second largest to the A3-size. A paper feeding target tray, in a case where the specification 2 specifies “Switch to a specific size”, is determined by the user specifying one of predetermined similar sizes of “A5 size→statement size”, “A4 size→letter size”, “A3 size→ledger size”, “statement size→A5 size”, “letter size→A4 size”, and “ledger size→A3 size”.

The remaining number detecting unit 62, in Step 103 (S103), detects the remaining number of paper sheets in the user-specified tray and the remaining number of paper sheets in the replacement trays in the priority order determined in Step 102.

A determination as to whether the specification 1 specifies “Print on the same size of paper” or “Print at the same image size” is performed in Step 104 (S104). A transition is made to subsequent Step 105 (S105) in a case where “Print on the same size of paper” is specified. A transition is made to subsequent Step 200 (S200) in a case where “Print at the same image size” is specified.

The determining unit 64, in Step 105 (S105), compares the remaining numbers of paper sheets in each tray with the number of paper sheets required for the job in the priority order of the user-specified tray and the replacement trays, which are paper feeding target trays, and determines whether or not there exists a tray in which the remaining number of paper sheets is sufficient. A transition is made to subsequent Step 106 (S106) in a case, where there exists such a tray. A transition is made to subsequent Step 300 (S300) in a case where there does not exist such a tray.

The tray, found in Step 105 (S105), in which the remaining number of paper sheets is sufficient is set as a paper feeding target in Step 106 (S106), and a transition is made to subsequent Step 107 (S107),

The determining unit 64, in Step 107 (S107), determines whether or not the printable area of the paper accommodated in the paper feeding target tray set in Step 101 (S101) or in Step 106 (S106) is smaller than the printable area of the job. A transition is made to subsequent Step 108 (S108) in a case where the printable area of the paper is determined to be smaller than the printable area of the job. A transition is made to subsequent Step 400 (S400) in a case where the printable area of the paper is determined to be larger than the printable area of the job.

The image adjusting unit 66, in Step 108 (S108), sets a printable area that fits within the size of the paper accommodated in the paper feeding target tray (reduces the image size), and a transition is made to subsequent Step 400 (S400).

Next, the determining unit 64, in Step 200 (S200), in a case where “Print at the same image size” is specified, calculates the sum of the remaining numbers of paper sheets in the priority order of the user-specified tray and the replacement trays, which are paper feeding target trays, and determines whether or not the sum satisfies the number of sheets required for the job. A transition is made to subsequent Step 201 (S201) in a case where the sum is determined to satisfy the number of sheets required. A transition is made to subsequent Step 300 (S300) in a case where the sum is determined not to satisfy the number of sheets required.

The setting of the paper feeding target trays is restored in Step 300 (S300), and a transition is made to subsequent Step 400 (S400).

Trays that are selected to satisfy the number of sheets required for the job in Step 200 (S200) are set as a replacement tray group and as a paper feeding target, and the user-specified tray and the replacement tray group are combined into a paper feeding target tray group in Step 201 (S201).

The image adjusting unit 66, in Step 202 (S202), sets a printable area that fits within the sizes of all paper sheets set in the paper feeding targets, the user-specified tray and the replacement tray group.

The determining unit 64, in Step 203 (S203), determines whether or not the printable area set in Step 202 (S202) is smaller than the printable area of the job. A transition is made to subsequent Step 204 (S204) in a case where the printable area is determined to be smaller than the printable area of the job. A transition is made to subsequent Step 205 (S205) in a case where the printable area is determined to be larger than the printable area of the job.

The image adjusting unit 66, in Step 204 (S204), sets the printable area set in Step 202 (S202) to be a printable area for printing, and a transition is made to Step 206 (S206).

The printable area of the job is set to be a printable area for printing in Step 205 (S205), and a transition is made to Step 206 (S206).

An image is generated in Step 206 (S206) on the basis of the printable area sets in Step 204 (S204) or in Step 205 (S205), and a transition is made to Step 400 (S400).

A determination as to whether or not a paper feeding target tray is determined is performed in Step 400 (S400). A transition is made to Step 401 (S401) in a case where a paper feeding, target tray is determined. A transition is made to Step 402 (S402) in a case where a paper feeding target tray is not determined.

Paper is fed in Step 401 (S401) from a paper feeding target tray that is switched by the switching unit 68 among the paper feeding target tray determined in Step 101 (S101), the paper feeding target tray determined in Step 106 (S106), and the paper feeding target tray group determined in Step 201 (S201). Images are respectively formed at the image sizes adjusted with respect to the printable areas that are set (in S108 and S206), and processing ends.

Feeding of paper is requested in Step 402 (S402) on the display screen of the UI device 10 of the terminal apparatus 6 to set paper of a size specified by the job in the paper feeding unit 16a, and processing ends.

Next, an example of output of the image forming apparatus 4 that uses the paper feeding unit 16 according to one exemplary embodiment of the present invention will be described in detail.

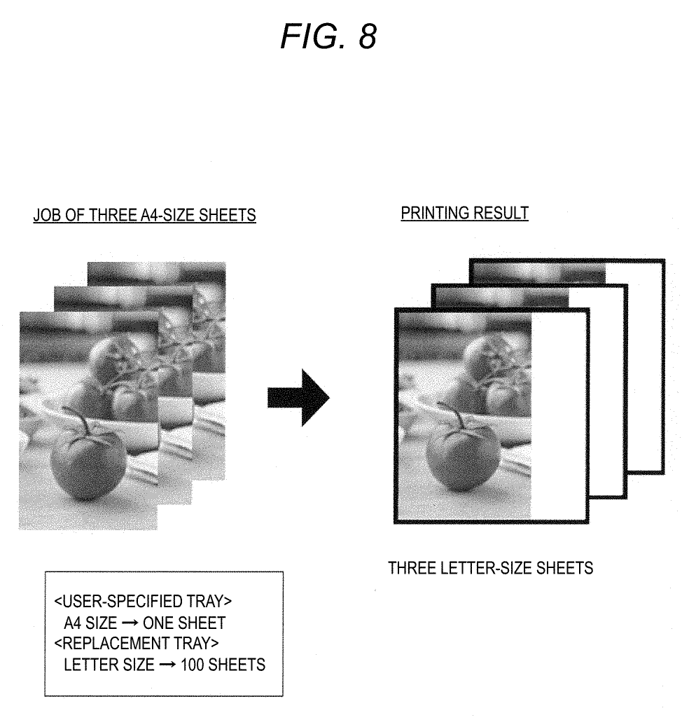

FIG. 8 illustrates an example of printing a job of three A4-size sheets, Description will be illustratively provided on the basis of FIG. 6 and FIG. 7 in a case where one sheet of A4-size paper is accommodated in the user-specified tray, 100 sheets of letter-size paper are accommodated in a replacement tray, the specification 1 specifies “Print on the same size of paper”, and the specification 2 specifies “Use Closest Size”. Since the specification 1 specifies “Print on the same size of paper” (No in S100), a paper feeding target tray is determined to be a tray accommodating A4-size paper, which is the user-specified tray, and since the specification 2 specifies “Use Closest Size”, a replacement tray is determined to be a tray accommodating letter-size paper to which priority is assigned in order from a size most similar to the A4 size (S102). The remaining numbers of paper sheets in the user-specified tray accommodating. A4-size paper and in the replacement tray accommodating letter-size paper are detected (S103). Since the specification 1 specifies “Print on the same size of paper” (Yes in S104), a determination as to whether or not the remaining number of paper sheets in the user-specified tray is larger than the number of sheets required for the job is performed (S105). The remaining number of paper sheets in the user-specified tray is one and is smaller than three which is the number of sheets required for the job, and the remaining number of paper sheets in the letter-size tray which is the replacement tray is 100 and satisfies the number of sheets required for the job in the present specific example. Thus, the replacement tray accommodating letter-size paper is determined to be a paper feeding target (S106), a printable area is set to fit within the printable area of letter-size paper (Yes in S107 and S108), paper is fed from the replacement tray accommodating letter-size paper to the image forming unit 22 (Yes in S400 and S401), and printing is performed on three sheets of letter-size paper. That is, the paper size is rendered uniform by selecting in advance the letter size paper that prevents exhaustion of paper, and the image size is rendered uniform as well by outputting images at the same image size.

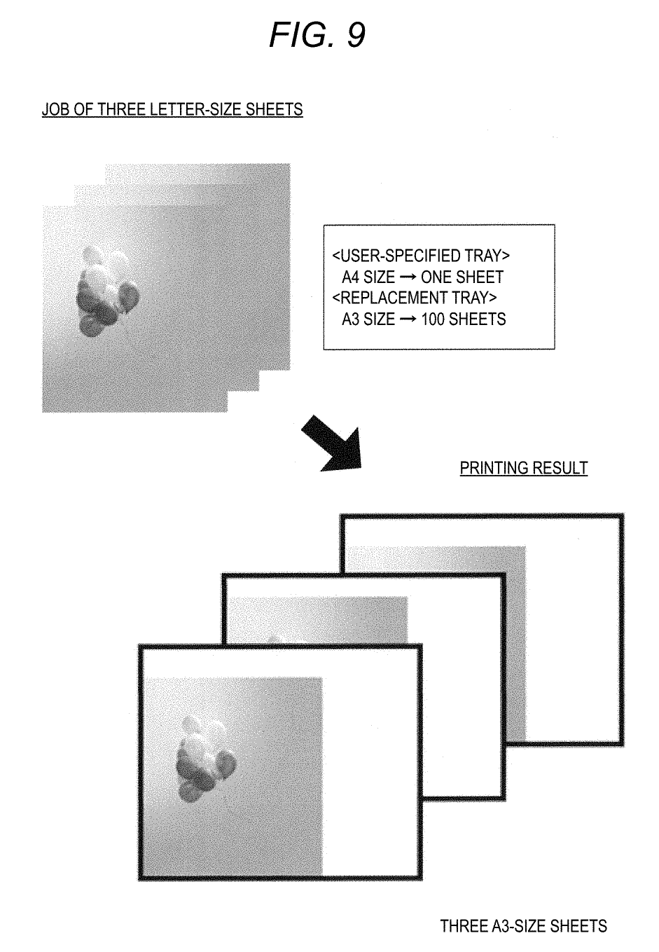

FIG. 9 illustrates an example of printing a job of three letter-size sheets. Description will be illustratively provided on the basis of FIG. 6 and FIG. 7 in a case where one sheet of letter-size paper is accommodated in the user-specified tray, 100 sheets of A3-size paper are accommodated in a replacement tray the specification 1 specifies “Print on the same size of paper”, and the specification 2 specifies “Use Larger Size”. Since the specification 1 specifies “Print on the same size of paper” (No in S100), a paper feeding target tray is determined to be a tray accommodating letter-size paper, which is the user-specified tray, and since the specification 2 specifies “Use Larger Size”, a replacement tray is determined to be a tray accommodating A3-size paper to which priority is assigned in order from a size larger than and most similar to the letter size (S102). The remaining numbers of paper sheets in the user-specified tray accommodating letter-size paper and in the replacement tray accommodating A3-size paper are detected (S103). Since the specification 1 specifies “Print on the same size of paper” (Yes in S104), a determination as to whether or not the remaining number of paper sheets in the user-specified tray is larger than the number of sheets required for the job is performed (S105). The remaining number of paper sheets in the user-specified tray is one and is smaller than three which is the number of sheets required for the job, and the remaining number of paper sheets in the A3-size tray which is the replacement tray is 100 and satisfies the number of sheets required for the job in the present specific example. Thus, the replacement tray accommodating A3-size paper is determined to be a paper feeding target (S106). Since the printable area of the paper is larger than the printable area of the job (No in S107), paper is fed from the replacement tray accommodating A3-size paper to the image forming unit 22 (Yes in S400 and S401), and printing is performed on three sheets of A3-size paper. That is, the paper size is rendered uniform by selecting in advance the A3 size paper that prevents exhaustion of paper, and the image size is rendered uniform as well by outputting images at the same image size.

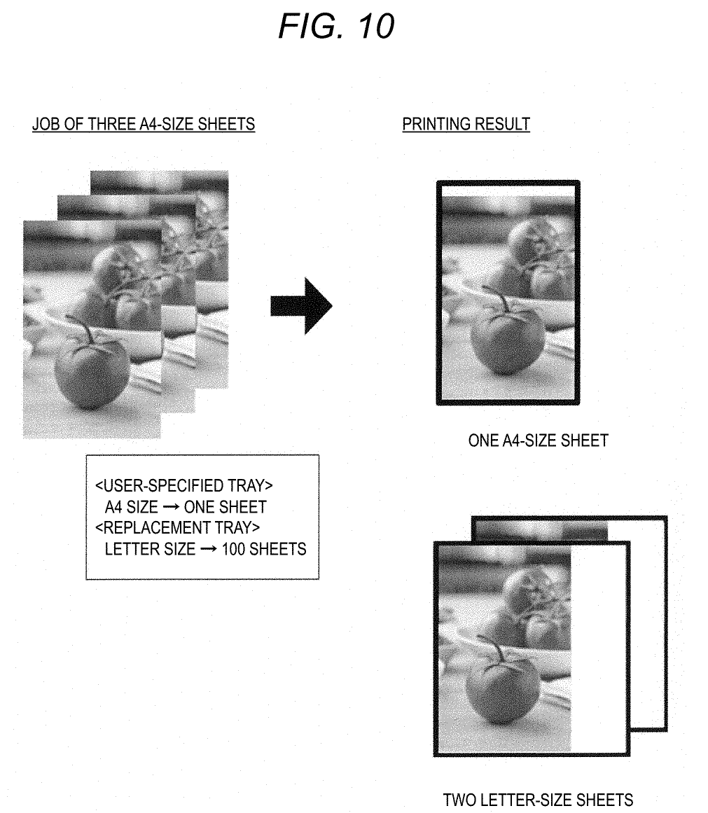

FIG. 10 illustrates an example, of printing a job of three A4-size sheets. Description will be illustratively provided on the basis of FIG. 6 and FIG. 7 in a case where one sheet of A4-size paper is accommodated in the user-specified tray, 100 sheets of letter-size paper are accommodated in a replacement tray, the specification 1 is set to “Print at the same image size”, and the specification 2 specifies “Use Closest Size”. Since the specification 1 specifies that “Print at the same image size” is set (No in S100), a priority order is assigned to paper feeding target trays in order from a size most similar to the A4 size in accordance with the user-specified tray, which is the A4-size tray, in S102 and the specification 2 that specifies “Use Closest Size”. The remaining number of paper sheets in the present specific example is detected from the tray, as a replacement tray, accommodating paper of the letter size that is most similar to the A4 size (S103). Since the specification 1 specifies “Print at the same image size” (No in S104), a determination as to whether or not to satisfy the number of sheets required for the job by using multiple trays is performed (S200). Since the remaining number of paper sheets in the user-specified tray is one and the remaining number of paper sheets in the replacement tray is 100 in the present specific example, the number of sheets required for the job, which is three, is determined to be satisfied by using the A4-size user-specified tray and the letter-size replacement tray (Yes in S200), and the A4-size user-specified tray and the letter-size replacement tray are set as paper feeding targets (S201). A printable area is set to fit within both the A4 size, which is a paper feeding target, and the letter size (S202). A determination as to whether or not the set printable area is smaller than the printed area of the job is performed (yes in S203). The printable area that is set to fit within both the A4 size and the letter size is set as a printable area for printing (S204), and images are generated (S206). The user-specified tray and the replacement tray are determined to be paper feeding targets, and paper is fed therefrom (Yes in S400 and S401). Printing is performed on one sheet of A4-size paper and on two sheets of letter-size paper in the paper feeding target trays at a reduced image size. That is, the image size is reduced to a size that covers the A4 size and the letter size, images are output at the same image size on different sizes of paper, and the image size is rendered uniform.

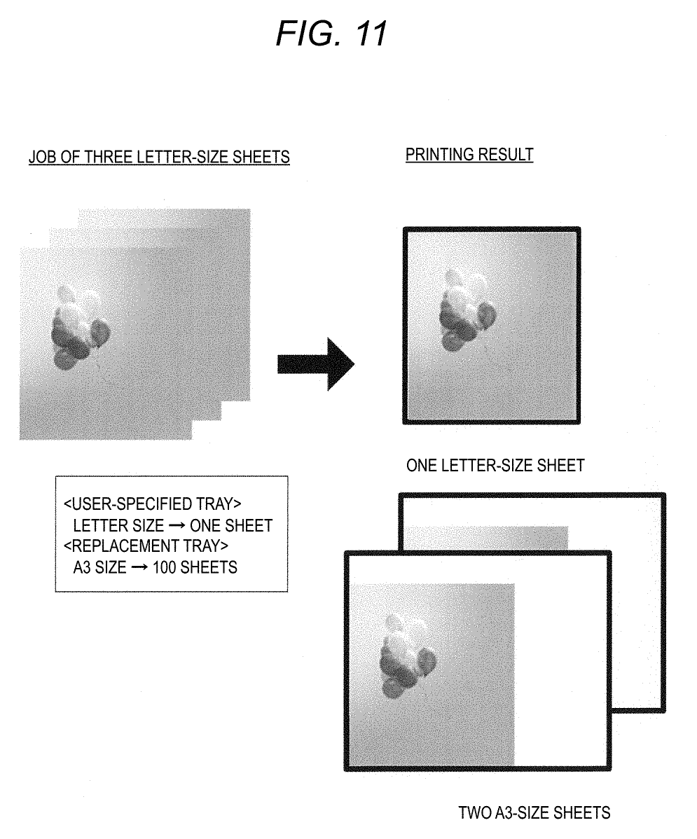

FIG. 11 illustrates an example of printing a job of three letter-size sheets. Description will be illustratively provided on the basis of FIG. 6 and FIG. 7 in a case where one sheet of letter-size paper is accommodated in the user-specified tray, 100 sheets of A3-size paper are accommodated in a replacement tray, the specification 1 is set to “Print at the same image size”, and the specification 2 specifies “Use Larger Size”. Since the specification 1 specifies that “Print at the same image size” is set (No in S100), a priority order is assigned to paper feeding target trays in order from a size larger than and most similar to the letter size in accordance with the user-specified tray, which is the letter-size tray, in S102 and the specification 2 that specifies “Use Larger Size”. The remaining number of paper sheets in the present specific example is detected from the tray, as a replacement tray, accommodating paper of the A3 size that is larger than and most similar to the letter size (S103). Since the specification 1 specifies “Print at the same image size” (No in S104), a determination as to whether or not to satisfy the number of sheets required for the job by using multiple trays is performed (S200). Since the remaining number of paper sheets in the user-specified tray is one and the remaining number of paper sheets in the replacement tray is 100 in the present specific example, the number of sheets required for the job, which is three, is determined to be satisfied by using the letter-size user-specified tray and the A3-size replacement tray (Yes in S200), and the letter-size user-specified tray and the A3-size replacement tray are set as paper feeding targets (S201). A printable area is set to fit within both the letter size and the A3 size which are the paper feeding targets. However, since the job of the letter-size is smaller than the printable area of A3 in the present specific example, the printable area of the job is set as the printable area (S202 and No in S203). That is, images are generated (S206) by using the printable area of the job as a printable area (S205), paper is fed from the user-specified tray and the replacement tray that are determined to be paper feeding targets (Yes in S400 and S401), and printing is performed on one sheet of letter-size paper and on A3-size paper in the paper feeding target trays. That is, images are generated within the printed area of the letter-size paper and are output at the same image size on different sizes of paper, and the image size is rendered uniform.

Next, an example of output according to a comparative example of the present invention will be described on the basis of FIG. 6 and FIG. 7.

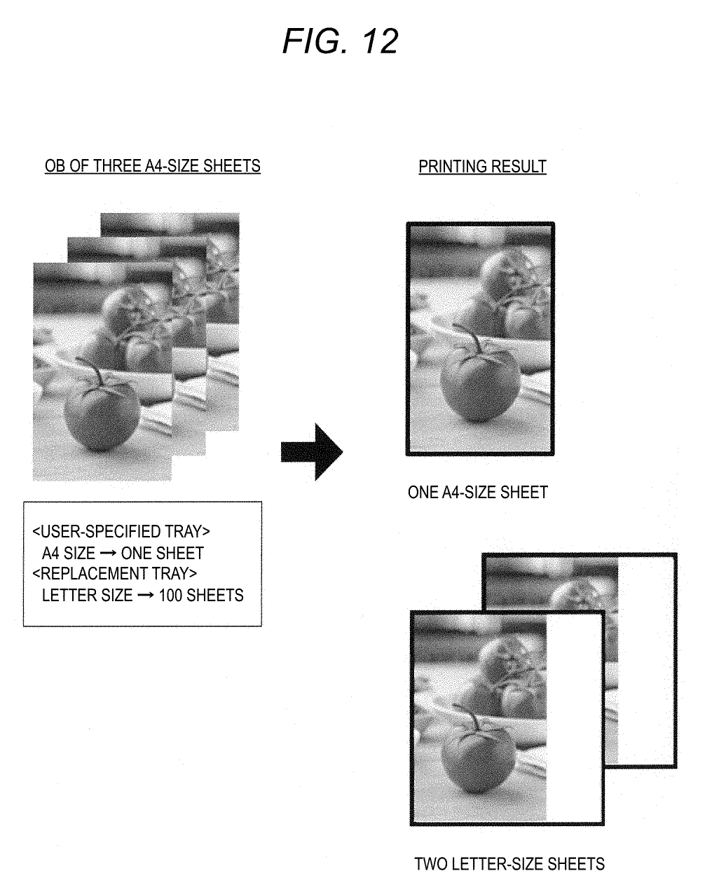

FIG. 12 illustrates an example of printing a job of three A4-size sheets. One sheet of A4-size paper is accommodated in the user-specified tray, and 100 sheets of letter-size paper are accommodated in a replacement tray. The specification 1 is set to “Do not consider paper exhaustion” (Yes in S100), and the specification 2 specifies “Use Closest Size”. While the printable area of A4-size paper is not changed since A4-size paper has the same printable area <as is the job (No in S107), the printable area of letter-size paper is changed (shrunk) since letter-size paper has a smaller printable area than the job (Yes in S107) (S108 and S400). When A4-size paper is fed and paper in the user-specified tray is exhausted, the paper feeding target is switched to the replacement tray. Letter-size paper is ted from the replacement tray (S401), and printing is performed on one A4-size sheet and on two letter-size sheets. That is, the paper size includes the A4 size and the letter size and is rendered irregular, and the image size is rendered irregular as well.

While the present exemplary embodiment is illustratively described in an example in which specifying feeding of paper and sending a specified job to the image forming apparatus 4 are performed on the display screen of the UI device 10 of the terminal apparatus 6, the present invention is not limited thereto. The image forming apparatus 4 may include a UI device to receive operations by the user, or a server apparatus may be used to receive operations by the user.

While the present exemplary embodiment is described in an example in which, in a case where the remaining number of recording media in the user-specified tray is small, paper is fed by making a switch in advance to a replacement tray in which the remaining number of recording media is sufficient and in an example in which the number of sheets of paper requited is fed as the sum of the number of sheets fed from the user-specified tray and the number of sheets fed from the replacement tray by making a switch to the replacement tray after the remaining number of recording media in the user-specified tray becomes zero, the present invention is not limited thereto. Printing may be performed again after the remaining number of recording media in the user-specified tray becomes zero, by making a switch to the replacement tray and feeding the required number of, sheets of paper again.

As described heretofore, the present invention may be applied to image forming apparatuses such as a photocopier, a printer, and a facsimile apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the to invention for various embodiments and with the various modifications as are suited to the particular use contemplated. It is intended that the scope of the invention be defined by the following claims and their equivalents.

1. An image forming apparatus comprising:
a receiving unit that receives image data;
a plurality of supply units that supplies different sizes of recording media;
a tray detecting unit that detects a supply unit to be set as a supply target from the plurality of supply units;
a switching unit that, according to the remaining number of recording media accommodated in the supply unit, makes a switch from supply by a supply unit, of the plurality of supply units, accommodating a recording medium of a size required for image formation to supply by another supply unit detected by the tray detecting unit; and
an adjusting unit that adjusts a printable area for printing of the image data received by the receiving unit to have the same output image size for all of the pages of a print job regardless of a switching operation by the switching unit, by adjusting the printable area in accordance with the size of the recording medium by comparing a first printable area of the image data and a second printable area that fits within all the different sizes of recording media.

2. The image forming apparatus according to claim 1, further comprising a remaining number detecting unit that detects the remaining number of recording media accommodated in the supply unit,
wherein the switching unit, according to a detection result of the remaining number detecting unit, makes a switch from supply by a supply unit, of the plurality of supply units, accommodating a recording medium of a size required for image formation to supply by another supply unit detected by the tray detecting unit.

3. The image forming apparatus according to claim 1, wherein the tray detecting unit detects a supply unit to be set as a supply target from the plurality of supply units by assigning a priority order on the basis of specification by a user.

4. The image forming apparatus according to claim 3, wherein the remaining number detecting unit detects the remaining number of recording media accommodated in the supply unit in the priority order assigned to the supply unit.

5. The image forming apparatus according to claim 1, wherein the switching unit makes a switch in advance from supply by the supply unit to supply by the other supply unit in a case where the remaining number of recording media accommodated in a supply unit, of the plurality of supply units, accommodating a recording medium of a size required for image formation is smaller than the number of recording media required for image formation.

6. The image forming apparatus according to claim 1, further comprising a requesting unit that requests supply of a recording medium to the supply unit,
wherein the requesting unit requests supply of a recording medium to the supply unit in a case where the number of recording media accommodated in the supply unit or in the other supply unit does not satisfy the number of recording media required for image formation.

7. The image forming apparatus according to claim 1, wherein the switching unit makes a switch from supply by the supply unit to supply by the other supply unit after the recording medium accommodated in the supply unit is exhausted, in a case where the remaining number of recording media accommodated in a supply unit, of the plurality of supply units, accommodating a recording medium of a size required for image formation is smaller than the number of recording media required for image formation.

8. The image forming apparatus according to claim 7, wherein the switching unit calculates the sum of the remaining numbers of recording media accommodated in the supply unit and in the other supply unit in the priority order assigned to the supply unit and makes a switch to satisfy the number of recording media required for image formation.

9. The image forming apparatus according to claim 8, further comprising a requesting unit that requests supply of a recording medium to the supply unit,
wherein the requesting unit requests supply of a recording medium to the supply unit in a case where the sum of the remaining numbers of recording media accommodated in the supply unit and in the other supply unit does not satisfy the number of recording media required for image formation.

10. An image forming method comprising:
receiving image data;
supplying different sizes of recording media;
detecting a supply unit to be set as a supply target from a plurality of supply units;
making a switch, according to the remaining number of recording media accommodated in the supply unit, from supply by a supply unit, of the plurality of supply units, accommodating a recording medium of a size required for image formation to supply by another supply unit; and
adjusting a printable area for printing of the received image data to have the same output image size for all of the pages of a print job regardless of a switching operation, by adjusting the printable area in accordance with the size of the recording medium by comparing a first printable area of the image data and a second printable area that fits within all the different sizes of recording media.

11. A non-transitory computer readable medium storing a program causing a computer to execute an image forming process, the image forming process comprising:
receiving image data;
supplying different sizes of recording media;
detecting a supply unit to be set as a supply target from a plurality of supply units;
making a switch, according to the remaining number of recording media accommodated in the supply unit, from supply by a supply unit, of the plurality of supply units, accommodating a recording medium of a size required for image formation to supply by another supply unit; and
adjusting a printable area for printing of the received image data to have the same output image size for all of the pages of a print job regardless of a switching operation, by adjusting the printable area in accordance with the size of the recording medium by comparing a first printable area of the image data and a second printable area that fits within all the different sizes of recording media.

12. The image forming apparatus according to claim 1, wherein if the second printable area is smaller than the first printable area, the adjusting unit sets the second printable area as the printable area for printing of the image data.

13. The image forming apparatus according to claim 1, wherein if the second printable area is not smaller than the first printable area, the adjusting unit sets the first printable area as the printable area for printing of the image data.
